(19) United States
(12) Patent Application Publication
(10) Pub. No.: US 2017/0080784 A1
(43) Pub. Date: Mar. 23, 2017

(54) DOOR TRIM AND VEHICULAR DOOR

(71) Applicant: TOYOTA BOSHOKU KABUSHIKI KAISHA, Aichi-ken (JP)

(72) Inventors: Kanji KOBAYASHI, Aichi-ken (JP); Kazuhiro TAWADA, Aichi-ken (JP); Kenji OKAMOTO, Aichi-ken (JP); Kimihiro IZUMI, Aichi-ken (JP)

(73) Assignee: TOYOTA BOSHOKU KABUSHIKI KAISHA, Aichi-ken (JP)

(21) Appl. No.: 15/210,253

(22) Filed: Jul. 14, 2016

(30) Foreign Application Priority Data
Sep. 18, 2015 (JP) 2015-184991

(51) Int. Cl. B60J 5/04; E06B 7/28

(52) U.S. Cl. CPC B60J 5/0413; E06B 7/28; B60J 5/0463; B60J 5/0469; E06B 2003/7049

(57) ABSTRACT

A door trim includes a first board member having a plate shape and a hole that is through the first board member, and a second board member having a plate shape and including a functional part integrally therewith. The second board member overlaps the first board member, and the functional part is in the hole and exposed to a vehicular interior side.

### CROSS REFERENCE TO RELATED APPLICATION

This application claims priority from Japanese Patent Application No. 2015-184991 filed on Sep. 18, 2015. The entire contents of the priority application are incorporated herein by reference.

### FIELD OF THE INVENTION

The present disclosure relates to a door trim and a vehicular door.

### BACKGROUND OF THE INVENTION

There has been known a vehicular door including a sealing screen arranged between a door trim and a door inner panel and the shock absorbing member is molded integrally with the sealing screen.

### SUMMARY OF THE INVENTION

According to the present technology, a door trim includes a first board member having a plate shape and a hole that is through the first board member, and a second board member having a plate shape and including a functional part integrally therewith. The second board member overlaps the first board member, and the functional part is in the hole and exposed to a vehicular interior side.

### BRIEF DESCRIPTION OF THE DRAWINGS

FIG. 1 is an exploded perspective view of a vehicular door according to one embodiment.

FIG. 2 is an exploded perspective view of a second board member.

FIG. 3 is a plan view of the second board member seen from a vehicular interior side.

FIG. 4 is a cross-sectional view of the vehicular door taken along line IV-IV in FIG. 3.

### DETAILED DESCRIPTION OF EMBODIMENTS

Products such as vehicles have been severely required to reduce a weight thereof and the number of parts. Vehicular doors are also required to reduce a weight thereof and the number of parts without deteriorating functional properties thereof.

However, with the configuration described in the above background art, only the arrangement position of the shock absorbing member is changed from that in the conventional configuration. The vehicular door is not substantially reduced in weight and the number of parts.

An objective of the present technology is to reduce a weight and the number of parts in the vehicular door.

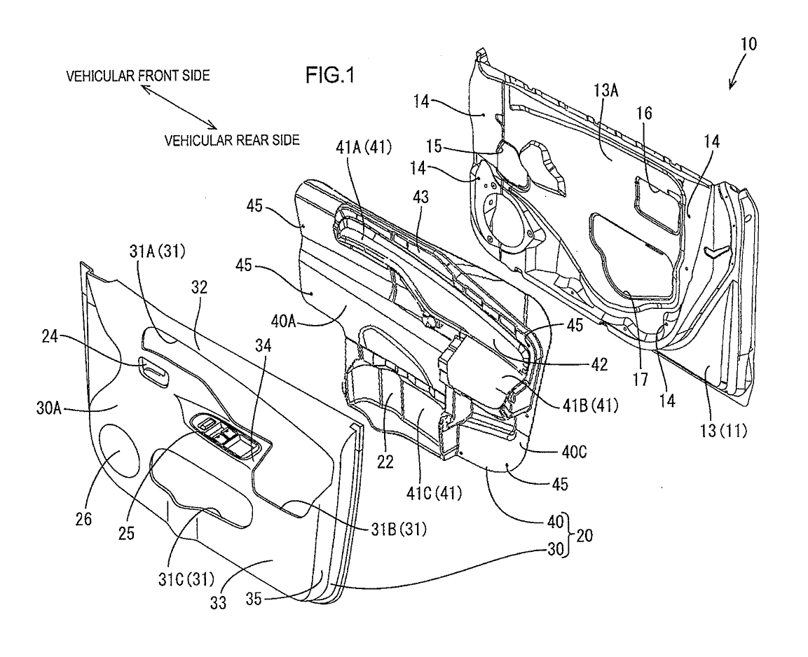

One embodiment of the present technology will be described with reference to FIGS. 1 to 4. A door outer panel 12 is not described in FIG. 1.

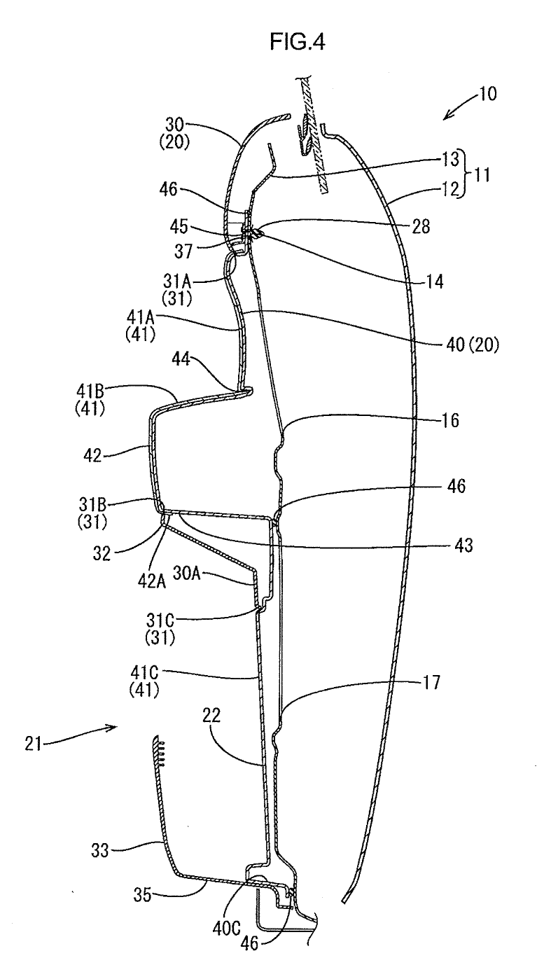

As illustrated in FIGS. 1 and 4, the vehicular door 10 includes a door panel 11, and a door trim 20 arranged on a vehicular interior side with respect to the door panel 11. The vehicular door 10 may be a side door that is arranged on a side of a seat arranged in the vehicle, for example. Mounting of the door trim 20 on the door panel 11 will be described later.

As illustrated in FIG. 4, the door panel 11 includes the door outer panel 12 and a door inner panel 13. Each of the panels 12, 13 is made of metal and formed by pressing a metal plate such as iron or aluminum. Various components such as an up-down mechanism for moving up and down a window glass (such as a window regulator or an electric motor, not illustrated), a locking mechanism for locking the vehicular door 10 (not illustrated), and a pressure sensor are arranged between the door inner panel 13 and the door outer panel 12 included in the door panel 11. The pressure sensor senses pressure change in an inner space of the vehicular door 10 and detects vehicle's side collision. A control part (not illustrated) installed in the vehicle is configured to activate an air bag installed in the vehicle (such as a side air bag) when pressure in the inner space of the vehicular door 10 is abruptly increased in case of the side collision.

As illustrated in FIGS. 1 and 4, the door inner panel 13 includes service holes 15-17 in a panel surface 13A. The above described various components are installed through the service holes 15-17 or maintenance work for the various components is carried out through the service holes 15-17. For example, the service hole 17 is provided for the window regulator. The door inner panel 13 has mounting holes 14 and the door trim 20 is mounted on the door inner panel 13 via the clips 28 that are through the respective mounting holes 14.

As illustrated in FIG. 4, the door trim 20 includes multiple functional parts facing the vehicular interior side. The functional parts represent parts having a specific function. In this embodiment, the functional parts include an ornament 41A, an arm rest 41B, a door pocket 21, an inside handle 24, a switch panel 25, and a speaker grill 26. In this embodiment, among the above functional parts, the ornament 41A, the arm rest 41B, and the door pocket 21 are represented as a functional part 41.

As illustrated in FIG. 1, the door trim 20 includes a first board member 30 and a second board member 40 that is overlapped the first board member 30. The first board member 30 and the second board member 40 mainly include a base member made of a synthetic resin material such as polypropylene. The material of the base member is not limited thereto but may be altered. For example, the base member of the first board member 30 may be obtained by mixing a wood material and synthetic resin. The base member of the second board member 40 may be obtained by mixing talc with synthetic resin to provide effective rigidity. The mounting of the first board member 30 and the second board member 40 will be described later.

As illustrated in FIG. 1, the first board member 30 includes a main surface portion 33 that is a vehicular interior side surface, and an extended surface 35 extending from a peripheral edge of the main surface portion 33 toward the vehicular exterior side. The first board member 30 has a substantially shallow bowl shape as a whole. The main surface portion 33 includes a first board member side projection portion 34 in a middle portion thereof with respect to a vehicular up-down direction and the first board member side projection portion 34 projects toward the vehicular interior side. The first board member side projection portion 34 includes a switch panel 25 in a vehicular front side portion thereof.

As illustrated in FIG. 1, the first board member 30 includes holes 31 in a plate surface 30A thereof. The holes 31 includes an ornament hole 31A, an armrest hole 31B, and a pocket hole 31C and are through holes that are through the first board member 30. The ornament hole 31A is in a vehicular upper side portion of the plate surface 30A and an ornament 41A is arranged in the ornament hole 31A. The armrest hole 31B is in a middle portion of the plate surface 30A with respect to a vehicular up-down direction and an armrest 41B is arranged in the armrest hole 31B. The pocket hole 31C is in a vehicular lower portion of the plate surface 30a and is an opening of a door pocket 21. The holes 31A, 31B, 31C are included in the holes 31.

As illustrated in FIG. 1, the ornament hole 31A is on an upper side with respect to the first board member side projection portion 34 and extends in the vehicular front-rear direction. The armrest hole 31B is on an vehicular rear side with respect to the first board member side projection portion 34. The first board member side projection portion 34 includes the armrest hole 31B in an upper surface and a vehicular interior side surface thereof. In this embodiment, the ornament hole 31A and the armrest hole 31B are communicated with each other. The pocket hole 31C is in a lower portion of the first board member side projection portion 34 and opens toward the vehicular interior side and the vehicular upper side (refer FIG. 4).

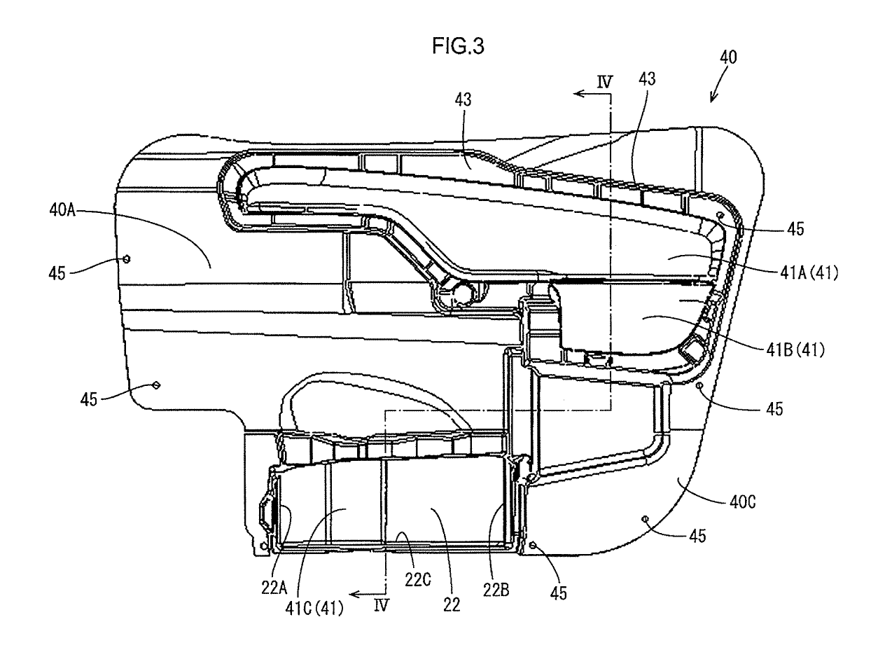

As illustrated in FIGS. 1 and 3, the second board member 40 has a substantially plate shape that is slightly smaller than the main surface portion 33. The second board member 40 includes functional parts 41 that are formed integrally therewith. The functional parts 41 include the ornament 41A, the armrest 41B, and a pocket back cover 41C that is a part of the door pocket 21. The second board member 40 includes the functional parts 41 in a middle portion thereof except for an outer peripheral edge portion 40C. The second board member 40 has a ring shape such that the flat outer peripheral edge portion 40C surrounds the functional parts 41. The second board member 40 includes a skin 42 collectively covering the ornament 41A and the armrest 41B. The skin 42 is not described in FIG. 3.

As illustrated in FIG. 3, the second board member 40 includes the ornament 41A in a position of a plate surface 40A thereof such that the ornament 41A fits in the ornament hole 31A and the ornament 41A extends in the vehicular front-rear direction and in the vehicular up-down direction. The ornament 41A is a plate-shaped part that is a relatively large one among the parts included in the door trim 20. The ornament 41A has a design surface that is seen from the vehicular interior side so that design of the door trim 20 is improved. In this embodiment, the skin 42 is the design surface of the ornament 41A and the door trim 20 has a high class design.

As illustrated in FIG. 4, the second board member 40 includes the armrest 41B in a position of the plate surface 40A such that the armrest 41B fits in the armrest hole 31B and the armrest 41B projects from the plate surface 40A toward the vehicular interior side to correspond to the shape of the first board member side projection portion 34. The armrest 41B has an upper surface and a vehicular interior side surface, and the upper surface is an armrest surface and the upper surface and the vehicular interior side surface are a design surface. In this embodiment, the skin 42 is the design surface of the armrest 41B. Therefore, the armrest 41B has nice and soft feeling and the door trim 20 has a high class design. The armrest 41B has a shape projecting toward the vehicular interior side. With such a configuration, the armrest 41B absorbs side collision energy and is compressed with pressure in case of the vehicle side collision and exhibits shock absorbing properties. The second board member 40 may include shock absorbing ribs below the armrest 41B to improve the shock absorbing properties of the armrest 41B, and the shock absorbing ribs project from the plate surfaces 40A toward the vehicular interior side.

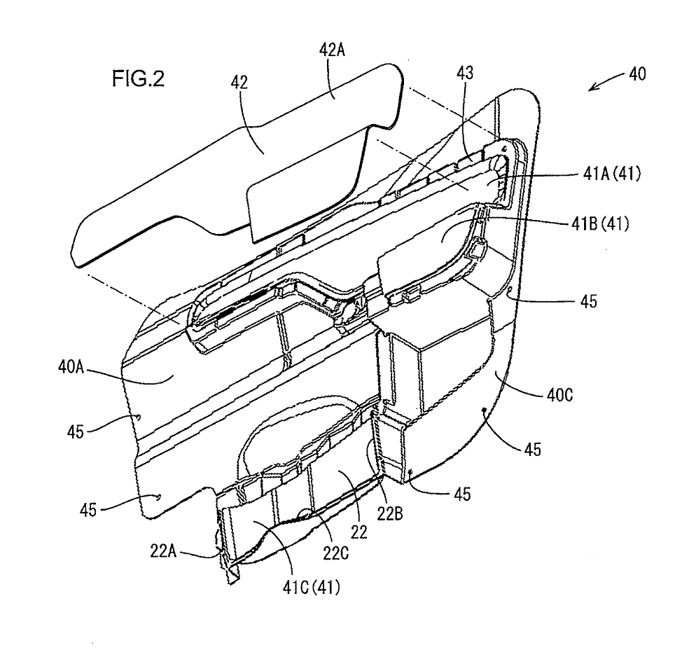

As illustrated in FIGS. 2 and 3, the second board member 40 includes a peripheral portion 43 around the ornament 41A and the armrest 41B. The peripheral portion 43 extends in a belt shape and surrounds the design surfaces of the ornament 41A and the armrest 41B. The peripheral portion 43 includes a step recessed toward the vehicular exterior side from the design surface and extends along the design surface. As illustrated in FIG. 4, the ornament 41A and the armrest 41B form a groove 44 at a border therebetween.

As illustrated in FIG. 2, the skin 42 is a sheet member made of leather, and the ornament 41A, the armrest 41B, and the peripheral portion 43 are collectively covered with the skin 42. If a flow mark or a weld line is generated in the second board member 40, the flow mark or the weld line can be covered with the skin 42. An outer peripheral edge portion 42A of the skin 42 is pressed by opening edges of the holes 31A, 31B of the first board member 30. Specifically, the edge portion 42A of the skin 42 is held between the peripheral portion 43 and the opening edges 32 of the ornament hole 31A and the armrest hole 31B. A part of the skin 42 is put in the groove 44 at the border between the ornament 41A and the armrest 41B (refer FIG. 4).

As illustrated in FIGS. 1, 3 and 4, the door pocket 21 has an inner surface 22, and the inner surface 22 includes a part of a vehicular exterior side surface of the main surface portion 33 and a part of a vehicular interior side surface of the plate surface 40A that is the pocket back cover 41C. The pocket back cover 41C is a vehicular exterior side portion of the inner surface 22 of the door pocket 21. In this embodiment, the pocket back cover 41C includes a base portion, a front wall portion 22A, a rear wall portion 22B, and a bottom wall portion 22C. The base portion is a part of the plate surface 40A of the second board member 40. The front wall portion 22A, the rear wall portion 22B, and the bottom wall portion 22C extend from an edge of the base portion. The front wall portion 22A is a vehicular front side portion of the inner surface 22, the rear wall portion 22B is a vehicular rear side portion of the inner surface 22, and the bottom wall portion 22C is a bottom surface of the inner surface 22. The door pocket 21 will be described later.

The mounting of each part will be described. As illustrated in FIG. 4, the first board member 30 and the second board member 40 are mounted on the door inner panel 13. Specifically, the first board member 30 includes clip seats 37 on a back surface thereof and the clip seats 37 project from the back surface. Clips 28 are mounted in the respective clip seat 37. The second board member 40 includes clip insertion holes 45 through which the clips 28 are inserted. The clip insertion holes 45 are formed in the outer peripheral edge portion 40C. The clips 28 mounted in the respective clip seats 37 are inserted through the clip insertion holes 45 and stopped by hole edges of the mounting holes 14 of the door inner panel 13. Accordingly, the first board member 30 and the second board member 40 are fixed to the door inner panel 13. In this embodiment, the first board member 30 is mounted on the door inner panel 13 after the second board member 40 is mounted on the door inner panel 13. Thus, the board members are mounted on the door inner panel 13 via two steps. The mounting of the board members is not limited thereto. For example, the first board member 30 and the second board member 40 may be mounted on each other and then, the first board member 30 and the second board member 40 may be mounted on the door inner panel 13 collectively at once.

As illustrated in FIG. 2, the second board member 40 is mounted on the door inner panel 13 to cover the service holes 15-17 collectively. As illustrated in FIG. 4, spaces between the second board member 40 and the inner panel 13 is sealed with a sealing member 46 having elasticity. The sealing member 46 is disposed on an area around each of the service holes 15-17. The sealing member 46 is an elongated member such as a butyl tape and disposed on an outer peripheral edge portion 40C of the second board member 40. According to such a configuration, rainwater is less likely to leak toward the vehicular interior side with respect to the second board member 40. The sealing member 46 is also disposed on a portion of the second board member 40 between the service hole 16 and the service hole 17. With such sealing members 46, the second board member 40 having a plate shape is less likely to be in contact with the door inner panel 13 and noise is less likely to be caused.

As illustrated in FIG. 4, the door trim 20 includes the first board member 30 and the second board member 40 that are overlapped with each other such that the ornament 41A, the armrest 41B, and the pocket back cover 41C, which are the functional parts, are uncovered and exposed to the vehicular interior side through the ornament hole 31A, the armrest hole 31B, and the pocket hole 31C, respectively.

As illustrated in FIG. 4, in the door trim 20, the ornament 41A and the armrest 41B are fit in the ornament hole 31A and the armrest hole 31B of the first board member 30, respectively. In the door trim 20, the plate surface 30A of the first board member 30 is flush with the design surfaces of the ornament 41A and the armrest 41B.

As illustrated in FIG. 4, in the door pocket 21 of the door trim 20, the pocket hole 31C is covered with and closed by the pocket back cover 41C and the pocket back cover 41C is opposite a lower portion of the first board member 30, and the lower portion is below the pocket hole 31C on the main surface portion 33 as illustrated in FIGS. 1 and 4. The lower portion of the first board member 30 and the pocket back cover 41C forms a storing space defined by the inner surface 22. The storing space is accessible through the pocket hole 31C included in the door pocket 21. According to such a configuration, objects such as plastic bottles and small objects are stored in the storing space of the door pocket 21 through the pocket hole 31C. The door trim 20 includes the first board member side projection portion 34 and the armrest 41B on a vehicular upper side with respect to the door pocket 21 and includes the pocket back cover 41C on the vehicular exterior side with respect to the first board member 30. Accordingly, the pocket back cover 41C is less likely to be seen by a vehicle occupant through the pocket hole 31C.

Next, advantageous effects of the present technology will be described. As described before, the door trim 20 according to the present embodiment includes the functional parts 41 that face and are exposed to the vehicular interior side. The door trim 20 includes the first board member 30 and the second board member 40, and the first board member 30 has a plate shape and has the hole 31 in the plate surface 30A, and the second board member 40 has a plate shape overlapping the first board member 30 and integrally includes the functional parts 41. The first board member 30 and the second board member 40 are overlapped with each other such that the functional parts 41 face and exposed to the vehicular interior side and are seen from the vehicular interior side.

If the first board member includes the functional parts and the second board member that has a plate shape is overlapped with the first board member, the door trim has a portion including the functional parts with a double structure where the first board member and the second board member are overlapped with each other. In the present embodiment, the portion of the door trim having the functional parts does not have such a double structure. Therefore, the mass of the vehicular door 10 as a whole is reduced by the portions corresponding to the holes 31. Further, the second board member 40 is used as a cover member so that rainwater and noise is less likely to leak into the vehicular interior side and accordingly, the functional parts 41 that are disposed on the vehicular exterior side with respect to the first board member 30 has a function as the cover member. Compared to a configuration in which the first board member, the functional parts, and the cover member are separately included in the door, the number of parts is reduced in the present embodiment. In the present embodiment, the second board member 40 is used as the cover member (a service hole cover) for covering the service holes 15-17.

In the present embodiment, the ornament 41A is an example of the first functional part 41 and the ornament hole 31A is an example of the first hole 31. The ornament 41A is a relatively large flat plate member included in the door trim 20 and with providing the ornament hole 31A that is a relatively large hole, the door trim 20 is reduced in weight quite effectively and the ornament 41A is used as a part of the cover member effectively.

In the present embodiment, the armrest 41B is an example of the second functional part 41 and the armrest hole 41B is an example of the second hole 31. The armrest 41B has a three-dimensional shape that projects from the vehicular interior side surface of the door trim 20 toward the vehicular interior side. When the first board member 30 is formed with press molding, a part thereof may be hard to be molded into the three-dimensional shape. Even in such a case, the armrest 41B is formed without having any problem regarding the molding by forming the second board member 40 having the armrest 41B with injection molding.

In the present embodiment, the pocket back cover 41C included in the door pocket 21 is an example of the third functional part 41 and the pocket hole 31C is an example of the third hole 31. The door pocket 21 is defined by the pocket back cover 41C, which is a vehicular exterior side portion, and a part of the main surface portion 33, which is a vehicular interior side portion, and thus the door pocket 21 has a double structure. Such a double structure is achieved effectively by the first board member 30 and the second board member 40. The pocket back cover 41C that is a vehicular exterior side portion of the door pocket 21 is less likely to be seen. Therefore, even if a flow mark or a weld line is generated in the second board member 40, design of the door trim 20 is less likely to be deteriorated.

In the present embodiment, the first board member 30 and the second board member 40 are collectively fixed to the door inner panel 13 and therefore, a cost for mounting the components together is not greatly increased and a design of the door trim 20 is less likely to be deteriorated due to the configuration of fixing the components together. Specifically, the door trim may be mounted on the door panel with swaging that is low cost fixing means. However, in molding a swaging boss, sink may be generated on a design surface. The door trim may be mounted on the door panel with using clips and with such fixing means, design is less likely to be deteriorated. However, a cost may be increased. Therefore, it is hard to achieve reducing a cost and improving design in fixing the components together. In many cases, a trim board (a member corresponding to the first board member 30) and an ornament board (a member corresponding to the second board member 40) are mounted together with bosses. However, in the present embodiment, with the above-described mounting structure according to the present embodiment, bosses are not used or the number of bosses is reduced. If the fixing means using clips that cost more than the fixing means with swaging is applied, the number of the fixing positions with the clips 28 is reduced compared to a configuration in which the first board member and the second board member are separately mounted on the door inner panel 13.

In the present embodiment, the edge portion 42A of the skin 42 is pressed by the opening edges 32 of the ornament hole 31A and the armrest hole 31B of the first board member 30. Therefore, the edge portion 42A of the skin 42 pressed by the first board member 30 is less likely to be peeled off and is less likely to be seen from the vehicular interior side. Accordingly, the design of the door trim 20 is improved. Further, the edge of the skin may be folded down toward a back surface of the functional part as a method of holding the edge of the skin. With such a method, the processes of folding down the skin toward the back surface of the functional part are required and wrinkles are likely to be caused in folding down the skin. In the present embodiment, such processes are not required and wrinkles are less likely to be caused.

In the present embodiment, the first board member 30 includes the holes 31 such as the ornament hole 31A, the armrest hole 31B, and the pocket hole 31C, and the second board member 40 includes the functional parts 41 such as the ornament 41A, the armrest 41B, and the pocket back cover 41C. With such a configuration, the mass of the door trim as a whole is reduced by the portions corresponding to the holes 31. The functional parts 41 restrict the rainwater and noise from leaking into the vehicular interior space and accordingly, exclusive parts for preventing the leaking are not required and the number of parts is reduced. Further, the functional parts 41 are integrally formed with the second board member 40. Therefore, compared to a configuration that the functional parts 41 are separately mounted on the first board member 30, the number of fixing portions is reduced in the door trim 20 as a whole.

In the vehicular door 10 of the present embodiment, the second board member 40 is mounted on the door inner panel 13 to close the service holes 15-17. Thus, the second board member 40 is used as the cover member (a service hole cover) to prevent the rainwater and noise from leaking into the vehicular interior space through the service holes 15-17 and therefore, the functional parts 41 disposed on the vehicular exterior side with respect to the first board member 30 have a function as the service hole cover. According to such a configuration, the number of parts is reduced compared to a configuration that each of the first board member, the functional parts, and the service hole cover is separately provided.

In many cases the service hole cover is covered with the door trim and therefore, the service hole cover is formed without increasing cost for improving its design, for example, for dealing with the flow mark or the weld line. The present inventors have an idea of providing the second board member 40 with a function of the service hole cover and using the second board member 40 as a design part that is exposed to and can be seen from the vehicular interior side, and implement the idea.

The service hole cover obtained by molding synthetic resin such as polyethylene into a film has been known. Such a film-shaped service hole cover is likely to be deformed with respect to a thickness direction thereof and pressure of an inner space of the vehicular door 10 may be varied due to the deformation. If pressure of the inner space of the vehicular door 10 is varied except for the case of side collision, detection performance of the pressure sensor may be adversely affected. In the present embodiment, the service holes are covered with and closed by the second board member 40 that is a plate member having rigidity greater than the film-shaped service hole cover. According to such a configuration, the pressure of the inner space of the vehicular door 10 is less likely to be varied except for the case of the side collision. Namely, the second board member 40 is a plate member included in the door trim 20 and also functions as a service hole cover that is preferable for detection performance of the pressure sensor with utilizing its mechanical properties.

In the present embodiment, the space between the second board member 40 and the door inner panel 13 is sealed with the sealing member 46 having elasticity, and the sealing member 46 is disposed around each of the service holes 15-17. Therefore, rainwater or noise is less likely to leak into the vehicular interior side through the space between the second board member 40 and the door inner panel 13. The second board member 40 further prevents rainwater or noise from leaking into the vehicular interior side through the service holes 15-17.

### Other Embodiments

The present technology is not limited to the description as described above with reference to the drawings. For example, the present technology may include following embodiments.

(1) The number of holes and functional parts may be changed as appropriate. For example, the first board member may include one hole and the second board member may include one functional part.

(2) The holes are not limited to the ornament hole, the armrest hole, and the pocket hole and the functional parts are not limited to the ornament, the armrest, and the door pocket (the pocket back cover). Combination of the holes and combination of the functional parts may be altered.

(3) Other than the above embodiments, the shape of each hole may be changed. For example, the hole may extend to the peripheral edge of the door trim.

(4) Other than the above embodiments, each of the first board member, the second board member, and the door inner panel may have different configurations and different shapes.

(5) Other than the above embodiments, the mounting of the first board member and the second board member may be altered if necessary. For example, each of the first board member and the second board member may be mounted on the door inner panel separately.

(6) The second board member may not be necessarily configured to function as the cover member covering the service hole. For example, the second board member may be mounted on a door inner panel including a film-shaped service hole cover.

(7) The second board member may not include the skin or may further include another skin covering the pocket back cover.

1. A door trim comprising:
a first board member having a plate shape and a hole that is through the first board member; and
a second board member having a plate shape and including a functional part integrally therewith, the second board member overlapping the first board member, and the functional part being in the hole and exposed to a vehicular interior side.

2. The door trim according to claim 1, wherein
the hole of the first board member includes an hole edge,
the second board member further includes a skin disposed on the functional part, and
the skin includes an edge portion that is pressed by the hole edge.

3. The door trim according to claim 1, wherein
the hole includes a first hole and a second hole,
the functional part includes a first functional part and a second functional part, and
the first functional part is in the first hole and exposed to the vehicular interior side through the first hole and the second functional part is in the second hole and exposed to the vehicular interior side through the second hole.

4. The door trim according to claim 1, wherein the first board member is on the vehicular interior side with respect to the second board member.

5. The door trim according to claim 1, wherein
the first board member has an inner surface facing the vehicular interior side, and
the inner surface of the first board member and the functional part that is in the hole of the first board member configure a vehicular interior side surface of the door trim.

6. The door trim according to claim 1, wherein the hole has a hole edge, and the hole edge has a size that fits the functional part.

7. The door trim according to claim 1, wherein
the second board member has an inner surface and the functional part projects from the inner surface of the second board member toward the vehicular interior side.

8. The door trim according to claim 2, wherein the edge portion of the skin is held between the hole edge of the first board member and the second board member.

9. A vehicular door comprising:
the door trim according to claim 1;
a door panel having a panel shape and including a service hole that is through the door panel, wherein
the second board member is mounted on the door panel with covering the service hole.

10. The vehicular door according to claim 9, wherein
the second board member and the door panel has a space therebetween, and
the space is sealed with a sealing member having elasticity and the sealing member is disposed around the service hole.
